(19) United States
(12) Patent Application Publication
(10) Pub. No.: US 2006/0201857 A1
(43) Pub. Date: Sep. 14, 2006

(54) Control device for water source filtering system

(75) Inventor: Yi Chou Lin, Changhua City (TW)

Correspondence Address: TROXELL LAW OFFICE PLLC, SUITE 1404, 5205 LEESBURG PIKE, FALLS CHURCH, VA, 22041, US

(73) Assignee: Lan Shan Enterprise Co., Ltd.

(21) Appl. No.: 11/074,631

(22) Filed: Mar. 9, 2005

(51) Int. Cl. B01D 35/143

(52) U.S. Cl. 210/85; 210/94

(57) ABSTRACT

A control device for a water source filtering system includes a water filtering system made up of a first cartridge of sediment pre-filter, a second cartridge of activated carbon filter to remove toxic chemicals, a third cartridge of refined pre-filter, a fourth cartridge of multi-layer reverse osmosis membrane, and a fifth cartridge of activated carbon post filter for sequential filtration of water source wherein the water filtering system works in cooperation with a control device quipped with a control panel having a series of indicator lights sequentially arranged at one side thereon to be respectively matched with the first-through-fifth cartridges thereby. The control panel thereof also has a display screen disposed at the upper section of the other side thereof, a pair of good and poor water quality indicator lights disposed at the middle section of the other side thereof, and a pair of setting and resetting/increasing keys disposed at the lower section of the other side thereof. Therefore, the control device can accurately record the replacement date of each cartridge from the first to the fifth and precisely send out light or alarm signals for speedy and correct replacement of the expired cartridges thereof, effectively reminding a user to regularly replace the worn-out cartridges so that, over long time of use, the water filtering system thereof can still efficiently filter the contaminants in water source and provide pure drinking water thereby.

### BACKGROUND OF THE INVENTION

The present invention is related to a control device for a water source filtering system, including a five-stage water filtering system, and a control device in cooperation with the water filtering system thereof wherein the control device can accurately record the replacement date of each cartridge of the water filtering system and precisely send out light or alarm signals for speedy and correct replacement of the expired cartridges thereof, effectively reminding a user to regularly replace the worn-out cartridges so that, over long time of use, the water filtering system thereof can still efficiently filter the contaminants in water source and provide pure drinking water thereby.

A conventional water filtering system is usually made up of filtering cartridges each regularly replaced after an assigned using time. As a result, a user must keep in mind or record the replacement date of the cartridges individually. In case the user neglects or forgets to replace the expired cartridges, the worn-out cartridges are unable to effectively filter the contaminants in water source, which, over long time of use, can accumulate sediments and bacteria therein to endanger the health of human body and, thus, reduce the function of the water filtering system thereof.

### SUMMARY OF THE PRESENT INVENTION

It is, therefore, the primary purpose of the present invention to provide a control device for water source filtering system, including a five-stage water filtering system, and a control device in cooperation with the water filtering system thereof wherein the control device can accurately record the replacement date of each cartridge of the water filtering system and precisely send out light or alarm signals for speedy and correct replacement of the expired cartridges thereof, effectively reminding a user to regularly replace the worn-out cartridges so that, over long time of use, the water filtering system thereof can still efficiently filter the contaminants in water source and provide pure drinking water for the health of human body thereby.

### BRIEF DESCRIPTION OF THE DRAWINGS

FIG. 1 is a perspective view of the present invention.

FIG. 2 is a block flowchart showing the adjustment process of the present invention.

### DETAILED DESCRIPTION OF THE PREFERRED EMBODIMENTS

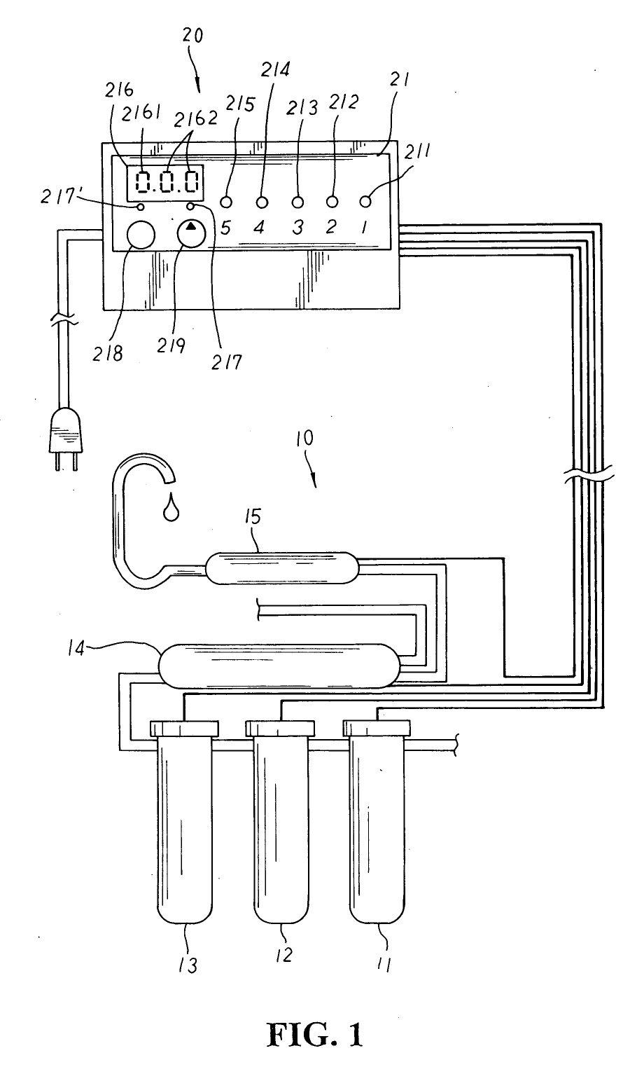

Please refer to FIG. 1. The present invention is related to a control device for a water source filtering system, including a water filtering system 10 made up of a first cartridge of sediment pre-filter 11, a second cartridge of activated carbon filter 12 to remove toxic chemicals, a third cartridge of refined pre-filter 13, a fourth cartridge of multi-layer reverse osmosis membrane 14, and a fifth cartridge of activated carbon post filter 15 to provide a sequential filtration of water source wherein the water filtering system 10 works in cooperation with a control device 20. The control device 20 thereof is equipped with a control panel 21 having a series of first through fifth indicator lights 211, 212, 213, 214, 215 sequentially arranged at one side thereon to be respectively matched with the five cartridges of the sediment pre-filter 11, the activated carbon filter 12, the refined pre-filter 13, the multi-layer reverse osmosis membrane 14, and the activated carbon post filter 15 thereby. The control panel 21 thereof also has a display screen 216 disposed at the upper section of the other side thereof, a pair of good and poor water quality indicator lights 217, 217′ disposed at the middle section of the other side thereof, and a pair of setting and resetting/increasing keys 218, 219 disposed at the lower section of the other side thereof.

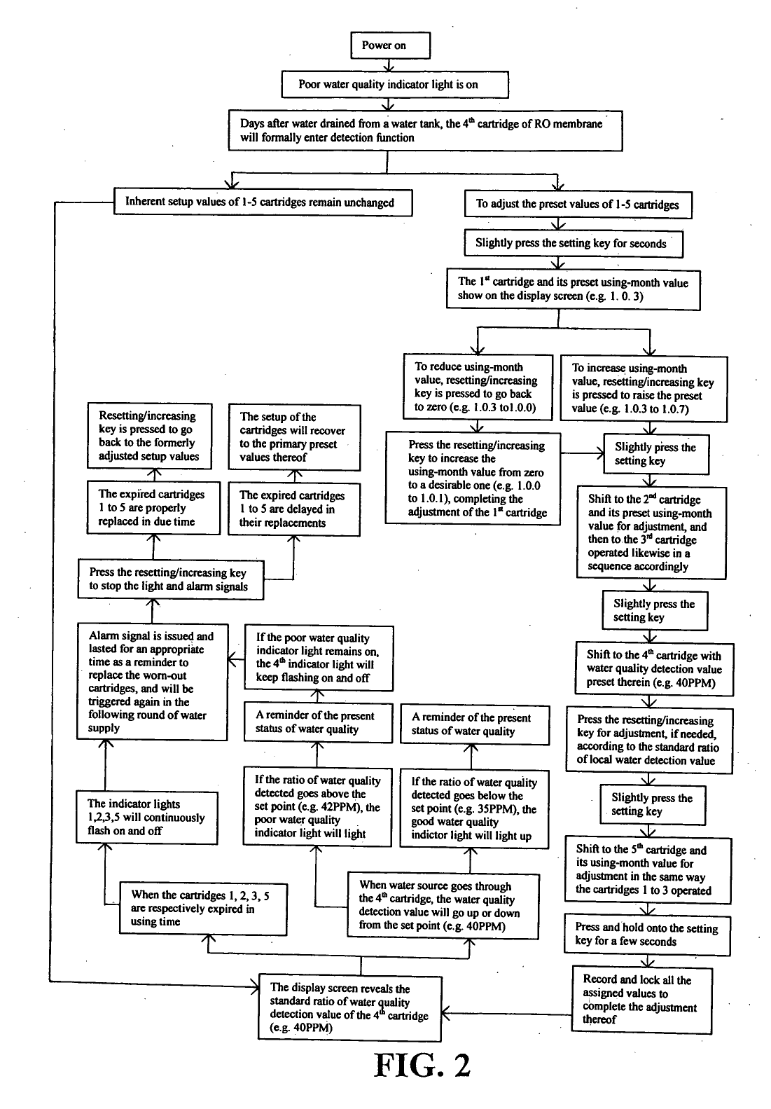

Please refer to FIG. 2 showing a block flowchart of the present invention. In operation, the poor water quality indicator light 217′ of the control device 20 will light up once the electrical power of the water filtering system 10 is turned on. And after a couple of days with water completely drained from a water tank, the fourth cartridge of multi-layer reverse osmosis membrane 14 will formally enter the detection function. All the cartridges 11, 12, 13, 14, 15 are respectively predetermined with an assigned value for the due time of replacement by the manufacturers. To adjust the primary setup thereof, the control device 20 must be operated as follows;

1. The setting key 218 of the control device 20 is slightly pressed for a few seconds, and the display screen 216 will show up a digital number 2161 representing the first cartridge 11 and a using-month value 2162 representing the preset time quantity (for example, 1.0.3 wherein the number 1 stands for the first cartridge 11, and the number 3 is a three-month using time for the first cartridge 11 thereof). To increase the using-month value 2162 of the first cartridge 11 (e.g. from 1.0.3 to 1.0.7), the resetting/increasing key 219 is slightly pressed to raise the set point of the primarily assigned using-month value 2162 thereof. To reduce the using-month value 2162, the resetting/increasing key 219 is continuously pushed till the using-month value 2162 thereof drops down to zero (e.g. from 1.0.3 to 1.0.0), and the resetting/increasing key 219 is slightly pressed again to increase the using-month value 2162 from zero to a desirable quantity to finish the adjustment of the first cartridge of the sediment pre-filter 11 thereof.

2. After the aforementioned operation thereof, the setting key 218 is slightly pressed to shift the digital number 2161 and the using-month value 2162 on the display screen 216 from the first cartridge 11 to the second cartridge of activated carbon filter 12 which, along with the third cartridge of refined pre-filter 13, is sequentially adjusted in a likewise manner as mentioned above. Then, the display screen 216 is shifted to the fourth cartridge of multi-layer reverse osmosis membrane 14 whose predetermined standard water-quality detection value (like 40 PPM) will show up on the display screen 216 thereof for adjustment, if necessary, depending on the standard ratio of the local water-quality detection value thereof. Afterwards, the setting key 218 is slightly pressed to adjust the digital number 2161 and the using-month value 2162 of the fifth cartridge of activated carbon post filter 15 thereby. Finally, when the first through fifth cartridges 11, 12, 13, 14, 15 thereof have been respectively done with the adjustment of the primary setup thereof as necessary, the setting key 218 is pressed and held on thereto for a few seconds to record all the assigned values and finish the adjustment thereof. Then, the standard ratio of water-quality detection value (like 40 PPM) set to the fourth cartridge of multi-layer reverse osmosis membrane 14 will reveal on the display screen 216 thereof. In case the setting key 218 is slightly pushed either not within an appropriate time period or with too short duration when the first-through-fifth cartridges 11, 12, 13, 14, 15 have finished the adjustment thereof, the setup of the cartridges 11, 12, 13, 14, 15 will go back to the primary preset values instead of the recently altered ones.

3. When water source goes through the fourth cartridge of multi-layer reverse osmosis membrane 14, the water-quality detection value revealed on the display screen 216 will jump up or down from the set point of standard ratio (like 40 PPM). If the water-quality detection value displayed shifts to a ratio (like 35 PPM) lower than the set point of the standard ratio thereof, the good water quality indicator light 217 will light up, while a higher ratio (like 42 PPM) thereof displayed will trigger the poor water quality indicator light 217′ as a warning signal to remind a user of the current water quality thereof.

4. When the poor water quality indicator light 217′ remains on and the other cartridges of the first, the second, the third, and the fifth 11, 12, 13, 15 are respectively expired in their using time thereof, the first through fifth indicator lights 211, 212, 213, 214, 215 will continuously flash on and off, and alarm signal will be issued as a reminder to the user to replace the worn-out cartridges 11, 12, 13, 14, 15 thereof. The alarm signal issued thereof will last only for an appropriate duration, but will go on when triggered again in the following round of water supply. And the resetting/increasing key 219 thereof is slightly pressed for a few seconds to shut down the indicator lights 211, 212, 213, 214, 215 as well as the alarm signal thereof.

5. When the expired first-through-fifth cartridges 11, 12, 13, 14, 15 are respectively replaced with a new one in due time, the resetting/increasing key 219 is simply pressed for a few seconds to go back to the previously adjusted set points thereof.

6. When the expired first-through-fifth cartridges 11, 12, 13, 14, 15 are delayed in their replacement thereof, the setup of the cartridges 11, 12, 13, 14, 15 will recover to the primary set points predetermined by the manufacturers thereof.

Therefore, the control device 20 in cooperation with the water filtering system 10 can accurately record the replacement date of each cartridge from the first to the fifth 11, 12, 13, 14, 15 and, via the first-through-fifth indicator lights 211, 212, 213, 214, 215, precisely send out light or sound alarm signals for speedy and correct replacement of the worn-out cartridges 11, 12, 13, 14, 15 thereof, effectively reminding the user to regularly replace the worn-out cartridges so that, over long time of use, the water filtering system 10 can still efficiently filter the contaminants in water source and provide pure drinking water for the health of human body thereby.

What is claimed is:

1. A control device for a water source filtering system, including a water filtering system made up of a first cartridge of sediment pre-filter, a second cartridge of activated carbon filter to remove toxic chemicals, a third cartridge of refined pre-filter, a fourth cartridge of multi-layer reverse osmosis membrane, and a fifth cartridge of activated carbon post filter to provide a 5-stage sequential filtration of water source thereby; the present invention being characterized by that,
the water filtering system works in cooperation with a control device quipped with a control panel having a series of indicator lights sequentially arranged from the first to the fifth at one side thereon to be respectively matched with the first-through-fifth cartridges thereby; the control panel thereof also has a display screen disposed at the upper section of the other side thereof, a pair of good and poor water quality indicator lights disposed at the middle section of the other side thereof, and a pair of setting and resetting/increasing keys disposed at the lower section of the other side thereof; thus, the control device can accurately record the replacement date of each cartridge from the first to the fifth thereof and, via the first-through-fifth indicator lights, precisely send out light or sound alarm signals for speedy and correct replacement of the expired cartridges thereof, effectively reminding the user to regularly replace the worn-out cartridges so that, over long time of use, the water filtering system thereof can still efficiently filter the contaminants in water source and provide pure drinking water thereby.

2. The control device for water source filtering system as claimed in claim 1 wherein once the electrical power of the water filtering system is turned on, the poor water quality indicator light of the control device will light up, and after a couple of days with water completely drained from a water tank, the fourth cartridge of multi-layer reverse osmosis membrane will formally enter the detection function; besides, all the cartridges are respectively preset with an assigned value by the manufacturers thereof.

3. The control device for water source filtering system as claimed in claim 1 wherein to alter the primary setup of the control device thereof, the setting key of the control device is slightly pressed for a few seconds, and the display screen will show up a digital number representing the first cartridge and a using-month value (for example, 1.0.3 wherein the number 1 stands for the first cartridge, and the number 3 is a three-month using time for the first cartridge thereof); to increase the using-month value of the first cartridge (e.g. from 1.0.3 to 1.0.7), the resetting/increasing key is slightly pressed to raise the set point of the using-month value thereof, and to reduce the using-month value, the resetting/increasing key is continuously pushed till the using-month value thereof drops down to zero (e.g. from 1.0.3 to 1.0.0), and the resetting/increasing key is slightly pressed again to increase the using-month value from zero to a desirable quantity to finish the adjustment of the first cartridge of the sediment pre-filter thereof;
after the aforementioned operation thereof, the setting key is slightly pressed to shift the digital number and the using-month value on the display screen from the first cartridge to the second cartridge of activated carbon filter which, along with the third cartridge of refined pre-filter, is sequentially adjusted in a likewise manner as mentioned above; then, the display screen is shifted to the fourth cartridge of multi-layer reverse osmosis membrane whose predetermined standard water-quality detection value (like 40 PPM) will reveal on the display screen thereof for adjustment, if necessary, depending on the standard ratio of the local water-quality detection value thereof; afterwards, the setting key is slightly pressed to adjust the using-month value of the fifth cartridge of activated carbon post filter thereby;
finally, when the first-through-fifth cartridges have been respectively done with the adjustment of the primary setup, the setting key is pressed and held on thereto for a few seconds to record all the assigned values and finish the adjustment thereof; then, the standard ratio of water-quality detection value (like 40 PPM) assigned to the fourth cartridge of multi-layer reverse osmosis membrane will reveal on the display screen thereof.

4. The control device for water source filtering system as claimed in claim 1 wherein when water source goes through the fourth cartridge of multi-layer reverse osmosis membrane, the water-quality detection value will jump up or down from the standard set point (like 40 PPM); in case the water-quality detection value revealed on the display screen shifts to a ratio (like 35 PPM) lower than the set point thereof, the good water quality indicator light will light up, while a higher ratio (like 42 PPM) displayed will trigger the poor water quality indicator light as a warning signal to remind a user of the current water quality thereof.

5. The control device for water source filtering system as claimed in claim 1 wherein when the poor water quality indicator light remains on and the other first, second, third, and fifth cartridges thereof are respectively expired in their using time, the first-through-fifth indicator lights will continuously flash on and off, and alarm signal will be issued as a reminder to the user to replace the worn-out cartridges thereof; the alarm signal issued thereof will last only for an appropriate duration and then stop, but will go on when triggered again in the following round of water supply; the resetting/increasing key thereof is slightly pressed for a few seconds to shut down the indicator lights as well as the alarm signal thereof.

6. The control device for water source filtering system as claimed in claim 1 wherein when the expired first-through-fifth cartridges are respectively replaced with a new one in due time, the resetting/increasing key is simply pressed for a few seconds for the cartridges to go back to the previously adjusted set points thereof.

7. The control device for water source filtering system as claimed in claim 1 wherein when the expired first-through-fifth cartridges are delayed in their replacement thereof, the setup of the cartridges will recover to the primary values predetermined by the manufacturers thereof.

8. The control device for water source filtering system as claimed in claim 1 wherein in case the setting key is slightly pushed either not within an appropriate time period or with too short duration when the first-through-fifth cartridges have finished the adjustment thereof, the setup of the cartridges will recover to the primary values assigned before the adjustment thereof.
